(19) United States
(12) Patent Application Publication
(10) Pub. No.: US 2010/0263168 A1
(43) Pub. Date: Oct. 21, 2010

(54) Gripping structure with an auxiliary handle of a bicycle

(76) Inventor: Chin-Long Hsieh, Taichung (TW)

Correspondence Address: Dr. BANGER SHIA;Patent Office of Bang Shia, 102 Lindencrest Ct, Sugar Land, TX, 77479-5201, US

(21) Appl. No.: 12/561,937

(22) Filed: Sep. 17, 2009

(30) Foreign Application Priority Data
Apr. 20, 2009 (TW) 098206578

(51) Int. Cl. B25G 1/10

(52) U.S. Cl. 16/430

(57) ABSTRACT

A gripping structure with an auxiliary handle of a bicycle comprises a body including a tubular member having an engaging end disposed on an outer end of the tubular member, including a sleeve having an end portion extending outward from the sleeve; an auxiliary handle fitted to the engaging end and including a clamping hole arranged on a bottom end thereof; a covering member made of a hard plastic material, covered to outer rims of the body and the auxiliary handle, and including a groove with a fitting end extending from the groove, the fitting end including an abutting plane fixed on an outer periphery thereof, the covering member also including a seat disposed on a side thereof where is in response to the end portion of the body and having a coupling side to connect with the body and having an arcuate side to contact with the auxiliary handle.

### BACKGROUND OF THE INVENTION

1. Field of the Invention

The present invention relates to component of a bicycle, and more particularly to a gripping structure with an auxiliary handle of a bicycle.

2. Description of the Prior Art

A conventional gripping structure with an auxiliary handle of a bicycle includes a tubular member made of hard plastic material and covered by a soft plastic sleeve, wherein the tubular member includes an engaging end, and the sleeve includes an end portion to be held by a user's palm, the end portion extends to the tubular member and out of the engaging end, therefore a groove is formed to fit an auxiliary handle, however because the end portion is made of soft plastic to support the auxiliary handle, as the auxiliary handle is rotated, it is deformed easily.

The present invention has arisen to mitigate and/or obviate the afore-described disadvantages.

### SUMMARY OF THE INVENTION

The primary object of the present invention is to provide a gripping structure with an auxiliary handle of a bicycle that can match with various auxiliary handles.

Another object of the present invention is to provide a gripping structure with an auxiliary handle of a bicycle that can enhance aesthetics appearance and comfort.

A gripping structure with an auxiliary handle of a bicycle in accordance with a preferred embodiment of the present invention comprises:

a body including a tubular member made of a hard plastic material and covered by a soft plastic sleeve, wherein the tubular member includes an engaging end disposed on an outer end thereof, the sleeve includes an end portion extending outward therefrom, and the end portion of the sleeve includes a locking tab mounted on a side thereof;

an auxiliary handle fitted to the engaging end of the tubular member of the body and including a clamping hole arranged on a bottom end thereof;

a covering member made of a hard plastic material and covered to outer rims of the body and the auxiliary handle, the covering member including a groove with a fitting end extending from the groove, and the fitting end including an abutting plane fixed on an outer periphery thereof, the covering member also including a seat disposed on a side thereof where is in response to the end portion of the body and having a coupling side to connect with the body and having an arcuate side to contact with the auxiliary handle, wherein the coupling side includes a retaining element, and an outer rim of the seat is formed in response to an outline of the end portion of the body so that the covering member matches with the end portion completely;

wherein the sleeve further includes a hollow decorating area formed on the end portion;

wherein the hollow decorating area is formed on the end portion and has a color different from that of the sleeve;

wherein the hollow decorating area is made of a material different from that of the sleeve;

wherein the locking tab is engaged with the retaining element of the coupling side;

wherein the auxiliary handle includes a recess communicating with the clamping hole and having a bolt element screwed into the recess to fasten the clamping hole;

wherein the clamping hole includes an annular surface fixed around an outer periphery thereof;

wherein the retaining element is a retaining notch.

### BRIEF DESCRIPTION OF THE DRAWINGS

FIG. 1 is a perspective view showing the exploded components of a gripping structure with an auxiliary handle of a bicycle in accordance with a preferred embodiment of the present invention;

FIG. 2 is a perspective view showing the assembly of the gripping structure with the auxiliary handle of the bicycle in accordance with the preferred embodiment of the present invention;

FIG. 3 is a top plan showing the assembly of the gripping structure with the auxiliary handle of the bicycle in accordance with the preferred embodiment of the present invention;

FIG. 4 is a cross sectional view showing two edges of an arcuate side being used to be upper and lower stopping points during rotating the auxiliary handle;

FIG. 5 is a perspective view showing a general auxiliary handle to be assembled to a body of the gripping structure completely.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

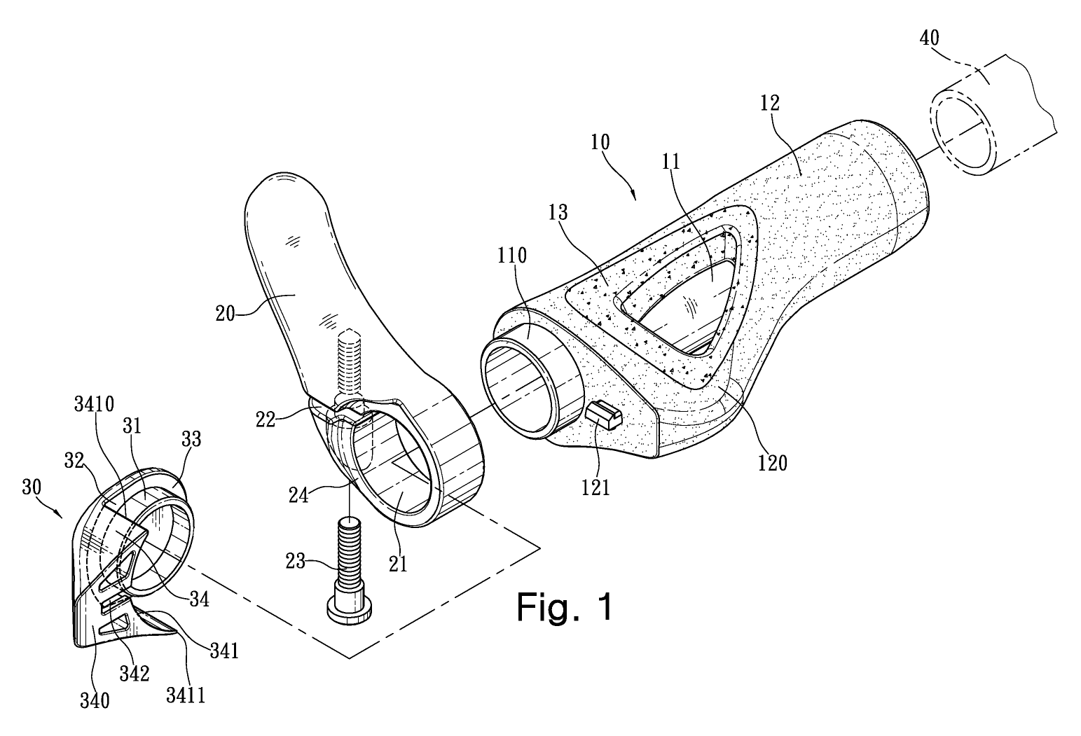

Referring to FIG. 1, a gripping structure with an auxiliary handle of a bicycle according to a preferred embodiment of the present invention comprises:

a body 10 including a tubular member 11 made of a hard plastic material and covered by a soft plastic sleeve 12, wherein the tubular member 11 includes an engaging end 110 disposed on an outer end thereof to fit an auxiliary handle 20, the sleeve 12 includes an end portion 120 extending outward therefrom to be held by a palm, and includes a hollow decorating area 13 formed on the end portion 120 and having a color or made of a material different from that of the sleeve 12 to enhance aesthetics appearance and comfort, the end portion 120 of the sleeve 12 includes a locking tab 121 mounted on a side thereof to be covered by a covering member 30;

the auxiliary handle 20 fitted to the engaging end 110 of the tubular member 11 of the body 10 and including a clamping hole 21 arranged on a bottom end thereof and a recess 22 communicating with the clamping hole 21 and having a bolt element 23 screwed into the recess 22 to fasten the clamping hole 21, and the clamping hole 21 including an annular surface 24 fixed around an outer periphery thereof;

the covering member 30 made of a hard plastic material and covered to outer rims of the body 10 and the auxiliary handle 20, the covering member 30 including a groove 32 with a fitting end 31 extending from the groove 32 to be fitted to a handle 40 which is fitted to the tubular member 11 of the body 10, and the fitting end 31 including an abutting plane 33 fixed on an outer periphery thereof to abut against the annular surface 24 of the clamping hole 21, such that the auxiliary handle 20 is clamped and limited on the outer rim of the body 10, and the covering member 30 also including a seat 34 disposed on a side thereof where is in response to the end portion 120 of the body 10 and having a coupling side 340 to connect with the body 10 and having an arcuate side 341 to contact with the auxiliary handle 20, wherein the coupling side 340 includes a retaining element 342 to engage with the locking tab 121 of the body 10, and two edges 3410, 3411 of the arcuate side 341 are used to be upper and lower stopping points during rotating the auxiliary handle 20, and an outer rim of the seat 34 is formed in response to an outline of the end portion 120 of the body 10 so that the covering member 30 matches with the end portion 120 completely.

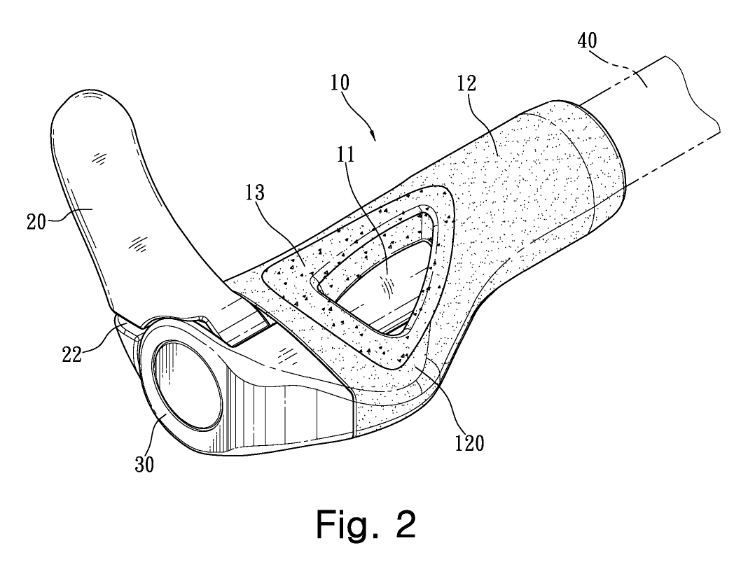

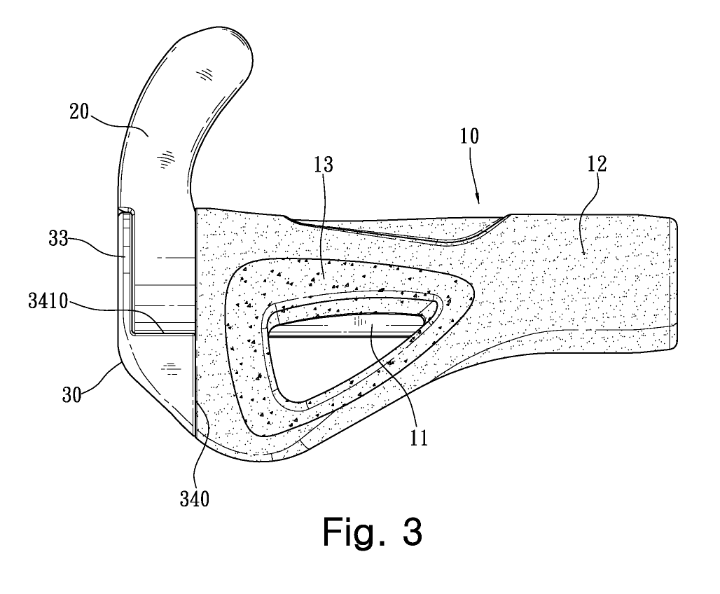

FIGS. 2 and 3, in assembly, the covering member 30 is tightly covered to the outer rim of the body 10, and a shape of the auxiliary handle 20 is formed in respond to that of the end portion 120 of the body 10, thereby forming a complete gripping structure with an auxiliary handle.

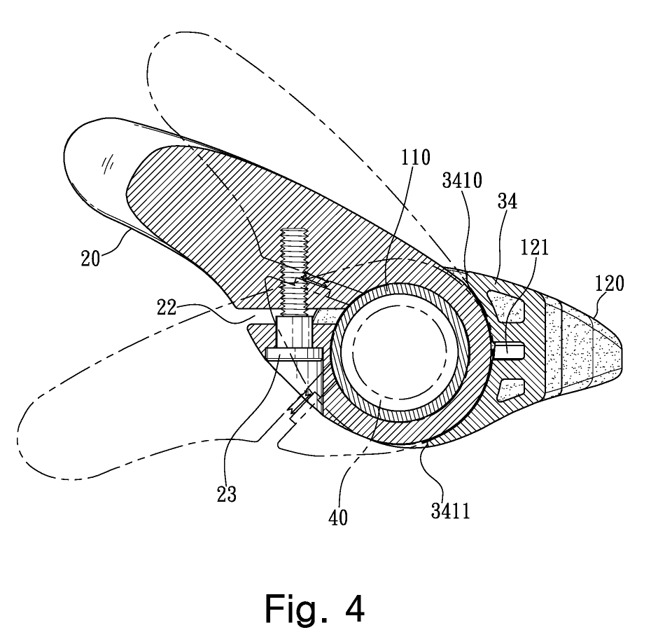

FIG. 4 is a cross sectional view showing the two edges 3410, 3411 of the arcuate side 341 being used to be upper and lower stopping points during rotating the auxiliary handle 20. In addition, because the covering member 30 is made of hard plastic material, it is strong enough to limit the auxiliary handle 20 and prevent the body 10 from deformation.

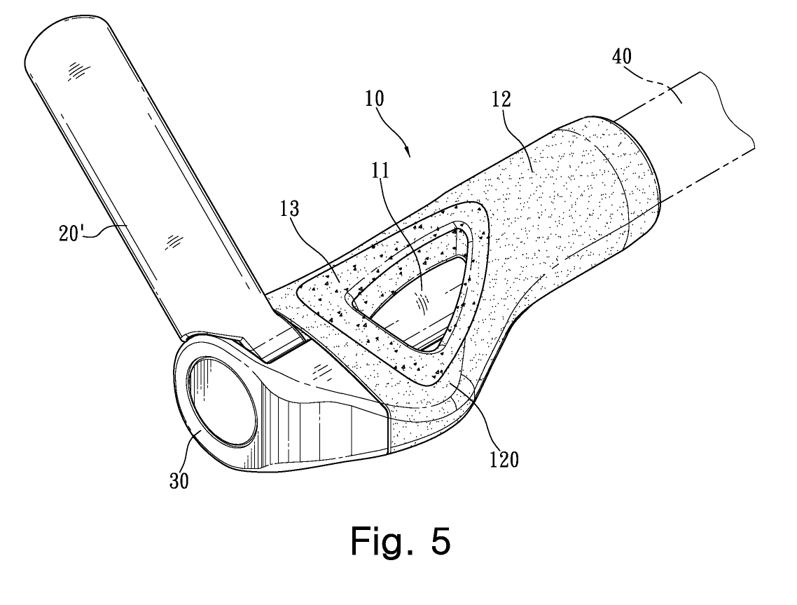

FIG. 5 is a perspective view showing a general auxiliary handle 20′ to be assembled to the body 10 completely.

It is apparent form the above description that the gripping structure with the auxiliary handle of the present invention has the following advantages:

1. The covering member is tightly covered to the outer rim of the body and formed in response to the end portion completely, enhancing aesthetics appearance.

2. Because the covering member is made of hard plastic material, it is strong enough to limit the auxiliary handle and prevent the body from deformation.

3. Because the covering member is tightly covered to the outer rim of the body and corresponds to the end portion of the body to clamp the auxiliary handle, thereby enabling to match with various auxiliary handles.

4. Due to the decorating area is hollow and includes a color or is made of a material different from that of the sleeve, enhancing aesthetics appearance and comfort.

While we have shown and described various embodiments in accordance with the present invention, it is clear to those skilled in the art that further embodiments may be made without departing from the scope of the present invention.

What is claimed is:

1. A gripping structure with an auxiliary handle of a bicycle comprising:
a body including a tubular member made of a hard plastic material and covered by a soft plastic sleeve, wherein the tubular member includes an engaging end disposed on an outer end thereof, the sleeve includes an end portion extending outward therefrom, and the end portion of the sleeve includes a locking tab mounted on a side thereof;
an auxiliary handle fitted to the engaging end of the tubular member of the body and including a clamping hole arranged on a bottom end thereof;
a covering member made of a hard plastic material and covered to outer rims of the body and the auxiliary handle, the covering member including a groove with a fitting end extending from the groove, and the fitting end including an abutting plane fixed on an outer periphery thereof, the covering member also including a seat disposed on a side thereof where is in response to the end portion of the body and having a coupling side to connect with the body and having an arcuate side to contact with the auxiliary handle, wherein the coupling side includes a retaining element, and an outer rim of the seat is formed in response to an outline of the end portion of the body so that the covering member matches with the end portion completely.

2. The gripping structure with an auxiliary handle of a bicycle as claimed in claim 1, wherein the sleeve further includes a hollow decorating area formed on the end portion.

3. The gripping structure with an auxiliary handle of a bicycle as claimed in claim 2, wherein the hollow decorating area is formed on the end portion and has a color different from that of the sleeve.

4. The gripping structure with an auxiliary handle of a bicycle as claimed in claim 2, wherein the hollow decorating area is made of a material different from that of the sleeve.

5. The gripping structure with an auxiliary handle of a bicycle as claimed in claim 1, wherein the locking tab is engaged with the retaining element of the coupling side.

6. The gripping structure with an auxiliary handle of a bicycle as claimed in claim 1, wherein the auxiliary handle includes a recess communicating with the clamping hole and having a bolt element screwed into the recess to fasten the clamping hole.

7. The gripping structure with an auxiliary handle of a bicycle as claimed in claim 1, wherein the clamping hole includes an annular surface fixed around an outer periphery thereof.

8. The gripping structure with an auxiliary handle of a bicycle as claimed in claim 1, wherein the retaining element is a retaining notch.
